(19) United States
(12) Patent Application Publication
(10) Pub. No.: US 2019/0366544 A1
(43) Pub. Date: Dec. 5, 2019

(54) Robot, Control Device And Method Of Controlling Robot

(71) Applicant: Seiko Epson Corporation, Tokyo (JP)

(72) Inventors: Hideaki OKA, Minowa (JP); Toshiyuki KAMIYA, Fujimi (JP); Mitsuhiro YAMAMURA, Suwa (JP)

(21) Appl. No.: 16/427,475

(22) Filed: May 31, 2019

(30) Foreign Application Priority Data
Jun. 1, 2018 (JP) 2018-106088

(51) Int. Cl. B25J 9/16; B25J 9/04

(52) U.S. Cl. CPC B25J 9/1666; B25J 9/04; B25J 9/1633; B25J 9/1694

(57) ABSTRACT

A robot includes a platform, a robot arm configured to rotate relatively to the platform, a force sensor configured to detect an external force, and a sensor section configured to detect that a physical body exists in a predetermined area set along the robot arm, wherein a detection value by the force sensor is corrected when the robot arm is one of at rest and operating at a uniform speed, and it is determined that no physical body exists in the predetermined area based on a detection result by the sensor section.

The present application is based on, and claims priority from, JP Application Serial Number 2018-106088, filed Jun. 1, 2018, the disclosure of which is hereby incorporated by reference herein in its entirety.

### BACKGROUND

### 1. Technical Field

The present disclosure relates to a robot, a control device and a method of controlling a robot.

### 2. Related Art

In the robot described in JP-A-2016-112627 (Document 1), a signal including a measurement value output from a force sensor reaches a control device, a force detection value is calculated in a force detection value calculation section based on the measurement value having reached the control device, and at the same time, the force detection value is updated as a correction value (the force sensor is reset) in the correction value updating section when a predetermined condition is fulfilled. Further, by frequently repeating the flow from the measurement of a force to the reset of the force sensor, a misfit amount between the correction value of the measurement value by the force sensor and a true value can always be kept in a minimum level.

In such a robot, there exists a delay (time lag) between the detection of the force by the force sensor and the execution of the reset by a control section. Therefore, when a human has contact with a robot arm at, for example, a certain time point ta, and the force sensor has detected the external force due to the contact, there is a possibility that the reset of the force sensor is executed at substantially the same time point ta. Specifically, since there exists the time lag from when the force sensor has detected the external force at the certain time point ta to when it is determined whether or not the reset of the force sensor is performed based on the measurement value of the external force, there is a possibility that the force sensor is reset at the same time point ta based on the measurement value of the external force which has been obtained at a time point earlier than the time point ta. Then, it results in that the measurement value by the force sensor is excessively corrected, and the misfit amount between the correction value of the measurement value by the force sensor and the true value increases.

In the robot described in Document 1, there is a problem that even in the state in which the force sensor is receiving the external force, the force sensor is reset, and thus the detection accuracy of the force sensor decreases.

### SUMMARY

A robot according to an application example of the present disclosure includes a platform, a robot arm configured to rotate relatively to the platform, a force sensor configured to detect an external force, and a sensor section configured to detect that a physical body exists in a predetermined area set along the robot arm, wherein a detection value by the force sensor is corrected when the robot arm is one of at rest and operating at a uniform speed, and it is determined that no physical body exists in the predetermined area based on a detection result by the sensor section.

### BRIEF DESCRIPTION OF THE DRAWINGS

FIG. 1 is a perspective view showing a robot according to a first embodiment of the present disclosure.

FIG. 2 is a block diagram of the robot shown in FIG. 1.

FIG. 3 is a flowchart for explaining a method of controlling the robot shown in FIG. 1 and FIG. 2.

FIG. 4 is a diagram showing an example of a monitoring area as a range which is set by a sensor section shown in FIG. 1, and in which it is detected that a physical body exists.

FIG. 5 is a diagram showing an example of the monitoring area as the range which is set by the sensor section shown in FIG. 1, and in which it is detected that a physical body exists.

FIG. 6 is a diagram for explaining an operation of the first embodiment by comparing an example of a motion of a grip section of a robot arm shown in FIG. 1 with respect to a component (a target), an example of a behavior of proximity sensors, and an example of a behavior of a control device along a time axis.

FIG. 7 is a perspective view showing a robot according to a second embodiment of the present disclosure.

FIG. 8 is a block diagram of the robot shown in FIG. 7.

FIG. 9 is a diagram showing an example of the monitoring area in which the proximity sensors shown in FIG. 7 detect that a physical body exists.

FIG. 10 is a perspective view showing a robot according to a third embodiment of the present disclosure.

FIG. 11 is a perspective view showing a robot according to a fourth embodiment of the present disclosure.

FIG. 12 is a diagram showing a robot according to a fifth embodiment of the present disclosure.

### DESCRIPTION OF EXEMPLARY EMBODIMENTS

Hereinafter, some preferred embodiments of a robot, a control device and a method of controlling a robot according to the present disclosure will be described in detail based on the accompanying drawings.

### First Embodiment

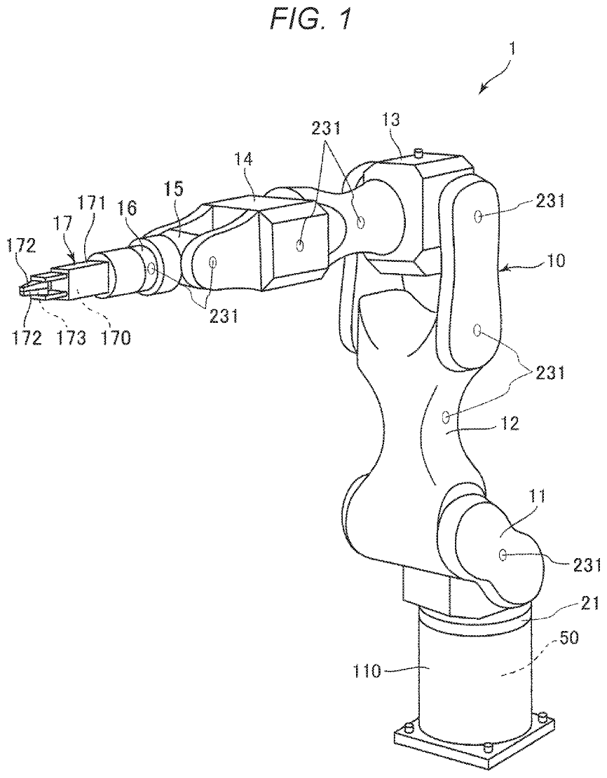

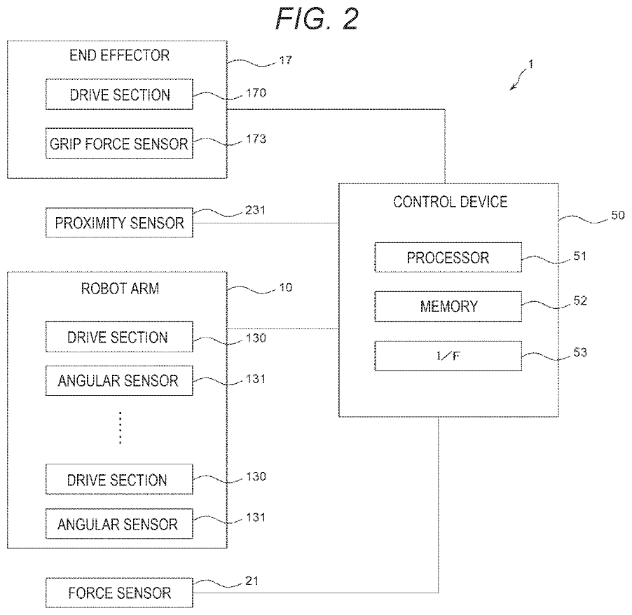

FIG. 1 is a perspective view showing a robot according to a first embodiment of the present disclosure. FIG. 2 is a block diagram of the robot shown in FIG. 1. It should be noted that hereinafter, a platform 110 side of the robot 1 is referred to as a “base end side,” and an opposite side (an end effector 17 side) thereof is referred to as a “tip side.”

The robot 1 shown in FIG. 1 is a system for performing works such as feeding, removing, conveying, and assembling of precision mechanical equipment or a component (a target) constituting the precision mechanical equipment using a robot arm 10 equipped with the end effector 17. The robot 1 is provided with the robot arm 10 having a plurality of arms 11 through 16, the end effector 17 attached to the tip side of the robot arm 10, and a control device 50 for controlling the operations of these constituents. Firstly, an outline of the robot 1 will hereinafter be described.

The robot 1 is a so-called 6-axis vertical articulated robot. As shown in FIG. 1, the robot 1 is provided with the platform 110 and the robot arm 10 rotating relatively to the platform 110.

The platform 110 is fixed to, for example, the floor, the wall, the ceiling, or a movable carriage. The robot arm 10 has an arm 11 (a first arm) rotatably coupled to the platform 110, an arm 12 (a second arm) rotatably coupled to the arm 11, an arm 13 (a third arm) rotatably coupled to the arm 12, an arm 14 (a fourth arm) rotatably coupled to the arm 13, an arm 15 (a fifth arm) rotatably coupled to the arm 14, an arm 16 (a sixth arm) rotatably coupled to the arm 15. It should be noted that a part which allows two members coupled to each other out of the platform 110 and arms 11 through 16 to bend or rotate against each other constitutes a “joint section.”

Further, as shown in FIG. 2, the robot 1 has drive sections 130 for driving the respective joint sections of the robot arm 10, and angular sensors 131 for detecting driving states (e.g., rotational angles) of the respective joint sections of the robot arm 10. The drive sections 130 are each configured including, for example, a motor and a reduction mechanism. The angular sensors 131 are each configured including, for example, a magnetic or optical rotary encoder.

To a tip surface of the arm 16 of such a robot 1, there is mounted the end effector 17. It should be noted that a force sensor can also be disposed between the arm 16 and the end effector 17.

The end effector 17 is a grip hand for gripping a target. As shown in FIG. 1, the end effector 17 has a main body 171, a drive section 170 installed in the main body 171, a pair of grip sections 172 opening and closing due to a drive force from the drive section 170, and a grip force sensor 173 provided in the grip sections 172.

Here, the drive section 170 is configured including, for example, a motor, a transmission mechanism such as a gear for transmitting the drive force from the motor to the pair of grip sections 172. Further, the pair of grip sections 172 opens and closes due to the drive force from the drive section 170. Thus, it is configured to hold a target by clipping the target between the pair of grip sections 172, or release the target held between the pair of grip sections 172. The grip force sensor 173 is a pressure-sensitive sensor such as a resistance-type pressure-sensitive sensor or a capacitance-type pressure-sensitive sensor, and is disposed in the grip sections 172, or between the grip sections 172 and the drive section 170 to detect the force applied between the pair of grip sections 172. It should be noted that the end effector 17 is not limited to the grip hand described above, but can also be, for example, an end effector of a type of holding the target by adsorption. The term “holding” in this specification is a concept including both of adsorption and grip. Further, “adsorption” is a concept including adsorption by magnetic force, suction by negative pressure, and so on. Further, the number of fingers of the grip hand used for the end effector 17 is not limited to two, but can also be three or more.

The control device 50 shown in FIG. 1 and FIG. 2 has a function of controlling the drive of the robot arm 10 based on the detection result of the angular sensors 131. Further, it is also possible for the control device 50 to have a function of determining a grip force of the end effector 17 or changing an operating condition of the robot 1 based on the detection result of the grip force sensor 173 and the operating condition of the robot 1.

The control device 50 has a processor 51 such as a central processing unit (CPU), a memory 52 such as a read only memory (ROM) and a random access memory (RAM), and an I/F 53 (an interface circuit). Further, by the processor 51 reading and then executing a program stored in the memory 52, the control device 50 realizes processes such as control of the actions of the robot 1 and the end effector 17, and a variety of types of arithmetic operations and determinations. Further, the I/F 53 is configured so as to be able to communicate with the robot 1 and the end effector 17.

It should be noted that the control device 50 is disposed inside the platform 110 of the robot 1 in the illustration, but this is not a limitation, and it is also configured to dispose the control device 50, for example, outside the platform 110 or inside the robot arm 10. Further, it is also configured to connect a display device provided with a monitor such as a display, an input device provided with a mouse or a keyboard, and so on to the control device 50.

Further, the robot 1 shown in FIG. 1 and FIG. 2 is provided with a force sensor 21 disposed closer to a base end than the robot arm 10, and between the robot arm 10 and the platform 110.

The force sensor 21 is a sensor for detecting an external force applied to the robot arm 10. By disposing such a force sensor 21, when an external force is applied to the robot arm 10 or the end effector 17, the external force is transmitted to the force sensor 21 via the robot arm 10, and it is configured to detect an amplitude or a direction of the force in the force sensor 21. Thus, the robot 1 has a function of detecting the fact that the robot arm 10 or the end effector 17 has contact with a human or an object.

According to such a robot 1, in the case of performing a work using the end effector 17 in the normal operation described above, it is configured to more accurately perform the work. It should be noted that in the present disclosure, a human and an object are also referred to collectively as a “physical body.”

Further, the robot 1 shown in FIG. 1 and FIG. 2 is provided with proximity sensors 231 (a sensor section) installed in the robot arm 10. The proximity sensors 231 are sensors configured to detect the fact that a human or an object (a physical body) exists in a predetermined area set along the robot arm 10, namely a monitoring area D described later. By providing such proximity sensors 231, it is configured to detect whether or not a human or an object is located close to the robot arm 10. Thus, since it is configured to detect a previous stage to the contact of the human or the object with the robot arm 10, it is configured to previously figure out the fact that there is a possibility that the human or the object has contact with the robot arm 10. Further, the detection result of the proximity sensors 231 becomes one of the conditions for determining whether or not the reset of the force sensor 21 is to be executed using a method described later.

It should be noted that the reset of the force sensor 21 means that, for example, the detection value of the force by the force sensor 21 is set to zero or to an arbitrary value as an offset. In other words, it means that the detection value of the force by the force sensor 21 is corrected so that the detection value can be assumed as zero or the arbitrary value.

The control device 50 shown in FIG. 1 and FIG. 2 further has a function of resetting the force sensor 21 based on the detection result of the proximity sensors 231.

The I/F 53 (an interface) is configured so as to be able to communicate with the force sensor 21 and the proximity sensors 231.

The outline of the robot 1 is described hereinabove. When an external force is applied to the robot 1, the robot 1 detects the external force with high accuracy in the force sensor 21, and operates in accordance with the detection result. Such a force sensor 21 is reset at an appropriate timing to thereby maintain a high detection accuracy. In other words, by performing the reset at an appropriate timing while preventing the reset at an inappropriate timing, reduction in the detection accuracy is prevented. As a result, in the robot 1, it is configured to more accurately perform an intended work such as a work for gripping or conveying a physical body based on the high detection accuracy in the force sensor 21. Hereinafter, this point will be described in detail.

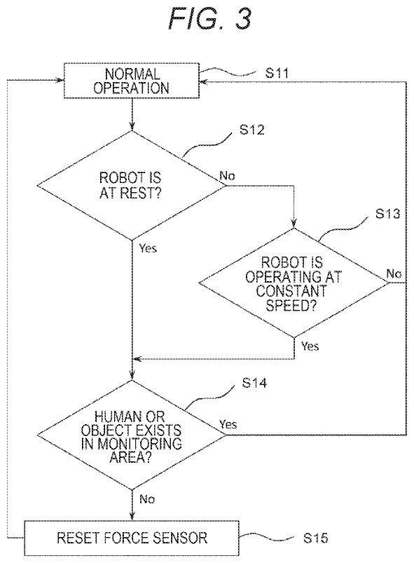

FIG. 3 is a flowchart for explaining a method (a control method by the control device 50) of controlling the robot shown in FIG. 1 and FIG. 2.

Firstly, the robot 1 starts (step S11) the normal operation. As the normal operation, there can be cited, for example, works such as feeding, removing, conveying, and assembling of precision mechanical equipment or a component (a target) constituting the precision mechanical equipment.

After the normal operation is started, whether or not the robot 1 is at rest is determined (step S12). Specifically, based on the signals from the angular sensors 131 disposed so as to correspond respectively to the arms 11 through 16 of the robot arm 10, it is determined that the robot 1 is at rest when all of the actions of the arms through 16 are stopped, or it is determined that the robot 1 is not at rest when any of the arms 11 through 16 are in action. It should be noted that in the step S12, it is also configured to arrange that whether or not the robot 1 is at rest is determined based on whether or not a signal for making the arms 11 through 16 act is output in the control device 50.

When it is determined that the robot 1 is at rest (Yes in the step S12), the transition to the step S14 described later is made.

In contrast, when it has been determined that the robot 1 is not at rest (No in the step S12), whether or not the robot 1 is operating at a constant speed is subsequently determined (step S13). In other words, whether or not the speed of the robot 1 in operation is constant is determined. Specifically, based on the signals from the angular sensors 131 disposed so as to correspond respectively to the arms 11 through 16 of the robot arm 10, it is determined that the robot 1 is operating at a constant speed when all of those in action out of the arms 11 through 16 are acting at constant angular speeds, or it is determined that the operation speed of the robot 1 is not constant when any of the arms 11 through 16 are acting at nonconstant angular speed, namely acting while the angular speed is changing with time (accelerated or decelerated). It should be noted that in the step S13, it is also configured to arrange that whether or not the robot 1 is operating at constant speed is determined based on whether or not a command for making any of the arms 11 through 16 act at nonconstant angular speeds is included in the signal for making the arms 11 through 16 act in the control device 50.

When it is determined that the robot 1 is operating at a constant speed (Yes in the step S13), the transition to the step S14 described later is made.

In contrast, when it is determined that the operation speed of the robot 1 is not constant (No in the step S13), since it means that the time point is not suitable as the timing at which the reset of the force sensor 21 is performed, return to the normal operation (step S11) described above is performed.

When it is determined that the robot 1 is at rest, or when it is determined that the robot 1 is operating at the constant speed, whether or not a human or an object exists in the monitoring area D is subsequently determined (step S14) by the proximity sensors 231.

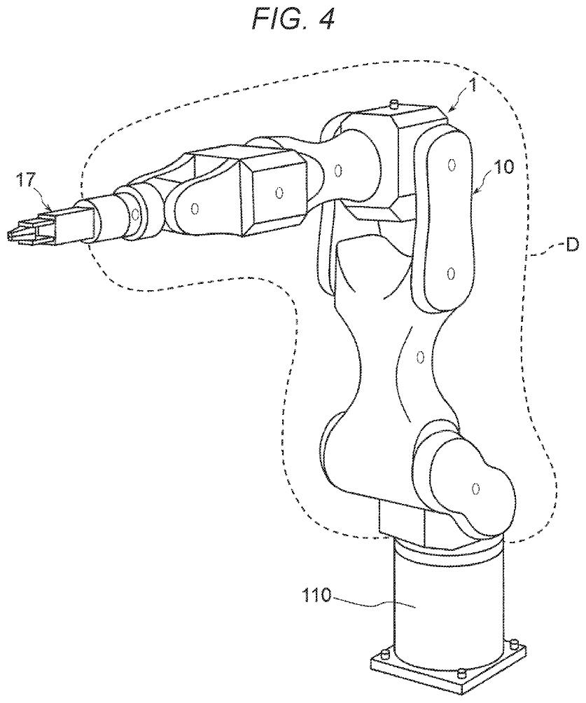

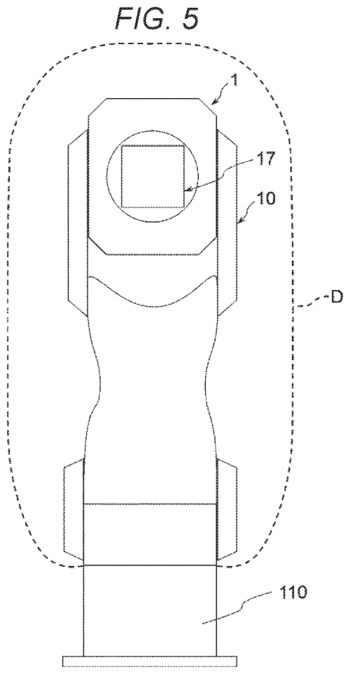

FIG. 4 and FIG. 5 are diagrams showing an example of the monitoring area D as the range which is set by the proximity sensors 231 (the sensor section) shown in FIG. 1, and in which it is detected that a human or an object exists. Such a monitoring area D can also be a limit space in which the proximity sensors 231 can detect a human or an object in view of the performance of the proximity sensors 231, or can also be a space in which the proximity sensors 231 detect a human or an object, and further, the detected distance is not longer than a threshold value, or the sensor output value is not lower than a threshold value (or not higher than a threshold value). Therefore, in the step S14, the process of determining whether or not a human or an object exists in the monitoring area D, for example, can also be a process of determining whether or not the proximity sensors 231 detect a human or an object, or can also be a process of determining whether or not the proximity sensors 231 detect a human or an object, and then the detected distance is not longer than the threshold value, or the sensor output value is not lower than the threshold value (or not higher than the threshold value).

Further, the robot 1 shown in FIG. 1 is provided with the plurality of proximity sensors 231 installed in the robot arm 10. The plurality of proximity sensors 231 is arranged at arbitrary intervals along a surface of the robot arm 10. Thus, the detectable range which one proximity sensor 231 has charge of can be expanded to a broad range in accordance with the number of the proximity sensors 231. As a result, it is configured to form the monitoring area D shaped like a barrier set so as to cover the surface of the robot arm 10 as shown in FIG. 4 and FIG. 5. Thus, it is configured to evenly monitor the periphery of the robot arm 10, and therefore, it is configured to more surely detect approach of a human or an object in the proximity sensors 231.

It should be noted that the number of the proximity sensors 231 is not particularly limited, but can also be one. Further, the monitoring area D is not required to cover the robot arm 10, but can also be set only in a part of the surface. Further, the distances between the proximity sensors 231 can be equal to or different from each other.

Further, the separation distance between an outer edge of the monitoring area D and the robot arm 10 is set in accordance with the size, the operation speed or the like of the robot arm 10, and is therefore not particularly limited, but is set to be not shorter than 5 mm and not longer than 1 m, as an example.

Due to such a process as described above, when it is determined that a human or an object exists in the monitoring area D (Yes in the step S14), it means that the time point is not suitable as the timing for resetting the force sensor 21, and therefore, the control flow is returned to the normal operation (step S11).

In contrast, when it is determined that a human or an object does not exist in the monitoring area D (No in the step S14), the force sensor 21 is subsequently reset (step S15).

Such a method of controlling the robot 1 is performed by the control device 50. Specifically, the control device 50 has the memory 52 (a storage section) and the processor 51 (a processing section) as described above. Further, the memory 52 stores an instruction which can be read by the processor 51, and the processor 51 resets the force sensor 21 based on the instruction stored in the memory 52 and the detection result of the proximity sensors 231.

Therefore, in the present embodiment, the processor 51 (the processing section) of the control device firstly obtains the detection result of the proximity sensors 231. Then, in the case of determining that a human or an object does not exist in the monitoring area D based on the detection result of the proximity sensors 231, and when the robot arm 10 is at rest or operating at a uniform speed, the processor 51 of the control device 50 outputs a signal for resetting the force sensor 21. According to such a process, since it is configured to efficiently perform the reset in the control device 50, it is configured to frequently perform the reset of the force sensor 21 as needed basis.

It should be noted that such a control device 50 performs the steps S11, S12, S13, S14 and S15 described above.

Further, as the instruction stored in the memory 52, there can be cited, for example, a threshold value for the detected distance of the human or the object detected by the proximity sensor 231.

It should be noted that, as described above, a limit range in which the proximity sensors 231 can detect a human or an object in view of the performance of proximity sensors 231 can be defined as the “monitoring area D,” or a range in which the proximity sensors 231 detect a human or an object, and further, the detected distance is not longer than the threshold value, or the sensor output value is not lower than the threshold value (or not higher than the threshold value) can also be defined as the “monitoring area D.” In the case of the former one, it is configured to determine that a human or an object does not exist in the monitoring area D based only on the detection result of the proximity sensors 231. Therefore, in this case, it is configured to reset the force sensor 21 without regard to the instruction stored in the memory 52, and therefore, the memory 52 becomes unnecessary for realizing this function. In contrast, in the case of the latter one, the detection result of the proximity sensors 231 and the instruction stored in the memory 52 are compared to each other, and when the detected distance exceeds the threshold value, or the sensor output value is not higher than the threshold value (or not lower than the threshold value), it is configured to determine that a human or an object does not exist in the monitoring area D.

It should be noted that it is configured to arrange that the instruction such as the threshold value for the detected distance stored in the memory 52 is updated as needed based on a variety of types of information changing with time.

Further, besides the threshold value for the detected distance, the instruction stored in the memory 52 can also be the data with which the threshold value for the detected distance can be calculated through a variety of arithmetic processes.

It should be noted that the monitoring area D related to the present embodiment is an area relatively set with reference to the surface of the robot arm 10, and is therefore shifted with the robot arm 10 when the robot arm 10 operates. It should be noted that the monitoring area D is not limited to the area relatively set in such a manner, but can also be an area absolutely set based on the range in which the robot arm 10 can operate irrespective of the operation of the robot arm 10.

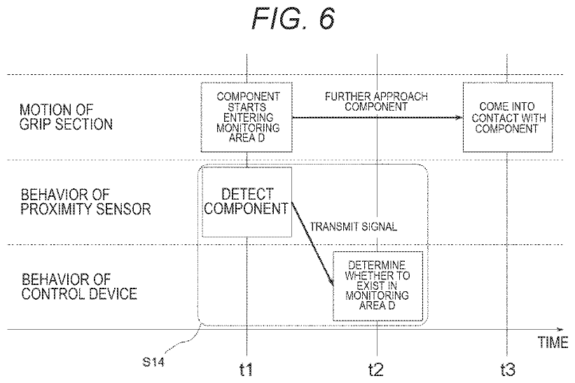

Here, since it takes certain time from the start to the completion of the execution of the step S14 described above, there exists a delay (time lag). FIG. 6 is a diagram for explaining the operation of the first embodiment by comparing an example of a motion of the grip section 172 of the robot arm 10 shown in FIG. 1 with respect to the component (the target), an example of a behavior of the proximity sensors 231, and an example of a behavior of the control device 50 along a time axis. It should be noted that in FIG. 6, the description will be presented citing, as an example, the case of defining the range in which the proximity sensors 231 detect a work, and further, the detected distance is not longer than the threshold value or the sensor output value is not lower than the threshold value (or not higher than the threshold value).

In FIG. 6, it is assumed that the robot arm approaches the component (the target) at a certain time point t1, and the component (the target) starts entering the monitoring area D. It is assumed that the robot arm 10 continues to approach the component (the target), and then the grip section 172 of the robot arm 10 moves so as to have contact with the component (the target) at a time point t3.

In contrast, the proximity sensors 231 detect the existence of the component (the target) at the time point tl, and then transmit the signals from the proximity sensors 231 to the control device 50. In the control device 50 having received the signals, the processor 51 determines whether or not the physical body exists in the monitoring area D. Then, the time point at which the signal for resetting the force sensor 21 becomes to be able to be output (it is determined that the reset signal is not to be output when the physical body exists) is set to t2. Therefore, the process from the time point t1 to the time point t2 corresponds to the step S14. On this occasion, a difference between the time point t2 and the time point t1 corresponds to the time lag in the information propagation or the information processing.

Conventionally, such a time lag has been a factor of a phenomenon that the force sensor is reset at an unintended timing. For example, in the related art example, the fact that the robot arm and the physical body have contact with each other is determined based on the variation of the output value of the force sensor for measuring the external force applied to the robot, but there is the time lag until whether or not the force sensor is to be reset is determined based on the measurement value of the external force. Therefore, in some cases, the force sensor is unintentionally reset at a time point t3 substantially the same time point at which the robot arm comes into contact with the physical body, and the external force derived from the contact is applied to the force sensor, and based on the measurement value which has been obtained at an earlier time point than the time point t3 in the state in which the robot arm and the physical body do not have contact with each other.

Therefore, in the present embodiment, there are used the proximity sensors 231 to detect that a human or an object approaches the robot arm 10 instead of detecting that a human or an object has contact with the robot arm 10. Therefore, the fact that there is a possibility that a human or an object comes into contact with the robot arm 10 can be detected at the time point before the contact occurs. If the fact that there is a possibility that the contact occurs in the near future can be detected in advance, namely in the stage at the time point t1, in such a manner, it is configured to ensure a temporal extension from when the proximity sensors 231 detect a human to when the contact actually occurs, namely a temporal extension from the time point t1 to the time point t3.

In general, such a temporal extension (t3-tl) can sufficiently absorb such a time lag (t2−t1) as described above. Specifically, since the time lag in the information propagation or the information processing is relatively short time, for example, even at the time point t2 when the time corresponding to the time lag has elapsed from when the component (the target) started entering the monitoring area D at the time point t1, the contact has not yet occurred. Therefore, even if the time lag exists, the determination that the signal for resetting the force sensor 21 is not to be output can be made in good time. Thus, it is configured to solve the problem in the related art, namely the problem that the force sensor 21 is reset despite the state in which an external force is acting on the force sensor 21. As a result, according to the present embodiment, it is configured to reset the force sensor 21 at a more appropriate timing to thereby keep the detection accuracy of the force sensor 21 in a high level.

Therefore, when the robot 1 is at rest, or when the robot 1 is operating at a constant speed and a human or an object does not enter the monitoring area D, an external force such as an inertial force is not applied to the force sensor 21, and at the same time, it is not the condition in which an external force is expected to act on the force sensor in the near future. Therefore, by performing the reset of the force sensor 21 at such timing, a more accurate offset correction can be performed. As a result, in the subsequent detection of the force by the force sensor 21, the misfit between the detection value corrected and the true value can be suppressed to the minimum. Thus, since the detection value of the force sensor 21 corrected becomes approximated to the true value, it is configured to further stabilize the operation of the robot 1.

As described above, the method of controlling the robot 1 is a method of controlling the robot 1 having the robot arm 10 and the force sensor 21 for detecting an external force, and has the step S14 of detecting that a human or an object (a physical body) exists in the monitoring area D (a predetermined area), and the step S15 of resetting the force sensor 21 when the robot arm 10 is at rest or operating at a uniform speed, and at the same time it is determined that a human or an object does not exist in the monitoring area D.

By adopting the determination that a human or an object does not exist in the monitoring area D as one of the conditions for resetting the force sensor 21 in such a manner, the fact that there is a possibility that a human or an object comes into contact with the robot arm 10 can be detected in advance. Thus, it is configured to reset the force sensor 21 at an appropriate timing at which no external force is acting on the force sensor 21 to thereby keep the detection accuracy of the force sensor 21 at a high level. Therefore, it is configured to enhance the safety and the reliability of the robot 1.

Further, the robot 1 has the robot arm 10, the force sensor 21 for detecting an external force, the proximity sensors 231 (the sensor section) for detecting that a human or an object (a physical body) exists in the monitoring area D (the predetermined area), and the processor 51 (the processing section) for resetting the force sensor 21 when the robot arm 10 is at rest or operating at a uniform speed, and at the same time it is determined that a human or an object does not exist in the monitoring area D based on the detection result of the proximity sensors 231.

According to such a robot 1, since it is arranged that it is configured to detect that a human or an object does not exist in the monitoring area D set in the periphery of, for example, the robot arm 10 as described above, the fact that there is a possibility that a human or an object comes into contact with the robot arm 10 can be detected in advance. Thus, it is configured to reset the force sensor 21 at an appropriate timing at which no external force is acting on the force sensor 21 to thereby keep the detection accuracy of the force sensor 21 at a high level. As a result, it is configured to enhance the safety and the reliability of the robot 1.

Further, the control device 50 is a device for controlling the robot 1 having the robot arm 10 and the force sensor 21 for detecting an external force. Further, in response to the signal of detecting that a human or an object (a physical body) does not exist in the monitoring area D (the predetermined area), the control device 50 outputs the signal for resetting the force sensor 21 for detecting an external force applied to the robot arm 10 during the period in which the robot arm 10 is at rest or operating at a uniform speed. Then, the reset of the force sensor 21 is performed based on this signal. By integrally performing the detection of a human or an object in the monitoring area D and the output of the reset signal with the control device 50 in such a manner, it is configured to suppress the time lag to a particularly short period, and it is configured to more frequently perform the reset of the force sensor 21 on an as-needed basis.

Further, in the robot 1 according to the present embodiment, the force sensor 21 is disposed closer to the base end than the robot arm 10. In other words, the force sensor 21 shown in FIG. 1 is disposed between the robot arm 10 and the platform 110.

Since the force sensor 21 is disposed at such a position, it is configured for the force sensor 21 to efficiently detect the external force applied to the end effector 17 irrespective of the posture of the robot arm 10. Specifically, since the force sensor 21 is disposed closer to the base end than the robot arm 10, the external force to be applied to the end effector 17 is concentrated on the force sensor 21, and can therefore efficiently be detected.

It should be noted that the position at which the force sensor 21 is disposed is not limited to the position shown in FIG. 1, but can also be anywhere. Further, it is also configured to add another force sensor to the robot 1 in addition to the force sensor 21. On this occasion, it is also configured to arrange that the other force sensor is also reset in substantially the same manner as in the force sensor 21.

Further, as the measurement principle of the force sensor 21, there can be cited, for example, a piezoelectric method, a strain gauge method and a capacitance method. Among these methods, the piezoelectric method is preferably used, and the piezoelectric method using a quartz crystal is more preferably used. In other words, the force sensor 21 may be the sensor including a quartz crystal. Since such a force sensor 21 using the quartz crystal generates a particularly accurate amount of charge in accordance with the external force in a wide variety of magnitude levels, it is easy to realize both of a high sensitivity and a wide range. Therefore, such a force sensor is useful as the force sensor 21 used in the robot 2. Further, in the force sensor with the piezoelectric method using the quartz crystal, a circuit configuration for accumulating the charge generated by the external force in a capacitor section and then converting the charge thus accumulated into a voltage (Q-V conversion) is adopted in many cases. In this case, since it is necessary to periodically reset the charge in the capacitor section so that the charge in the capacitor section is not saturated (does not overflow), the present disclosure is particularly advantageous.

It should be noted that it is also configured to use two or more sensors different in type together as the force sensor 21.

In contrast, in the robot 1 according to the present embodiment, as described above, the plurality of proximity sensors 231 is disposed along the surface of the robot arm 10. Each of the proximity sensors 231 is arranged to be able to detect a distance between, for example, the surface of the robot arm 10 and the human or the object approaching the surface. Therefore, the monitoring area D shown in FIG. 4 is defined as, for example, the plurality of detectable ranges which the proximity sensors 231 respectively have charge of, and which are combined with each other.

It should be noted that the proximity sensors 231 each can also be disposed at a place other than on the surface of the robot arm 10 such as inside the robot arm 10 or at a position floating from the surface of the robot arm 10. Further, the proximity sensors 231 are not limited to those disposed on the surface or the like of the robot arm 10, but can also be disposed at positions separated from the robot arm 10.

Further, as described above, the proximity sensors 231 are sensors which can detect that a human or an object exists in the monitoring area D set in the periphery of the robot arm 10. As the proximity sensor 231, there can be cited a variety of types of ranging sensors such as an ultrasonic ranging sensor, an optical ranging sensor, a capacitance ranging sensor, an induction (eddy current) ranging sensor, a magnetic ranging sensor and an imaging ranging sensor. It should be noted that the proximity sensors 231 each can be one type of these ranging sensors, or can also be compound sensors constituted by a plurality of sensors including at least one type of these ranging sensors combined with each other.

Further, it is also possible for the proximity sensors 231 to have a function of providing conditions for stopping the operation of the robot arm 10 before the robot arm 10 has contact with a human or an object in addition to the function of providing the conditions for resetting the force sensor 21 described above. Specifically, it is also possible for the robot 1 to be arranged to be controlled so as to stop the operation of the robot arm 10 or reduce the speed of the operation of the robot arm 10 based on the detection result by the proximity sensors 231. Thus, it is configured to suppress the contact between the robot arm 10 and a human or an object to enhance the safety of the robot 1.

Further, in the method of controlling the robot 1 based on the flowchart shown in FIG. 3, the normal operation is normally started immediately after the reset of the force sensor 21 is completed. Therefore, it results in that the reset of the force sensor 21 is repeatedly performed at relatively short intervals, and it results in that the high detection accuracy is maintained.

### Second Embodiment

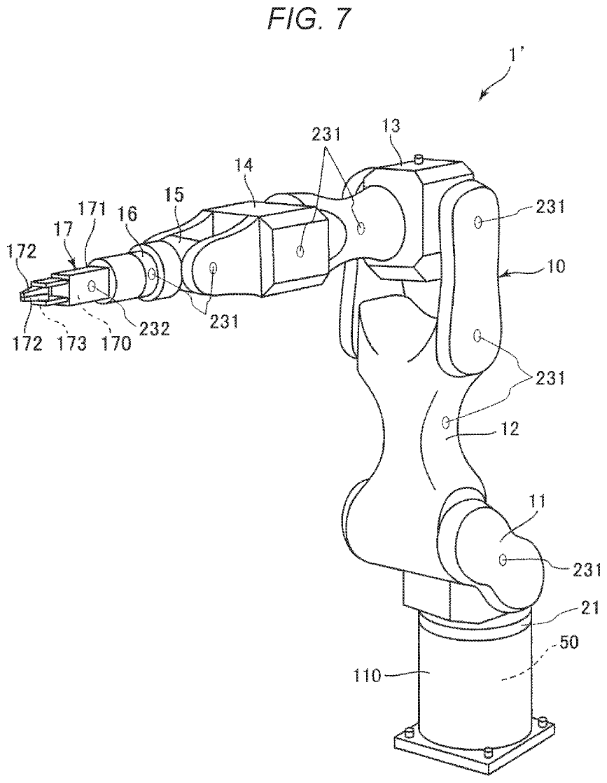

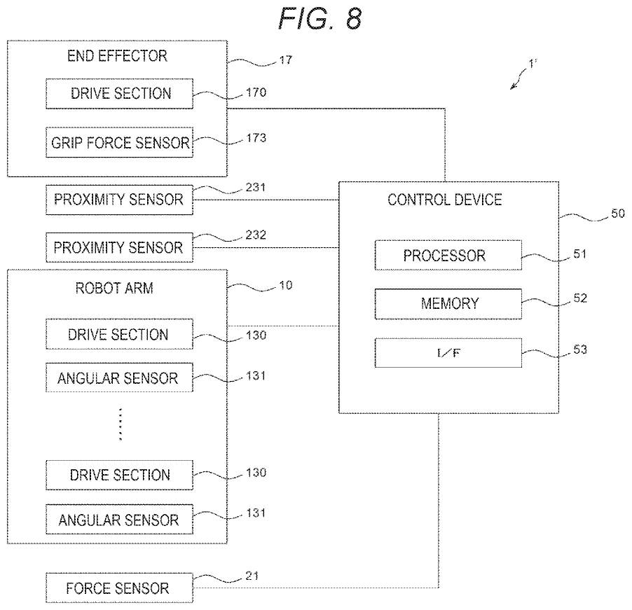

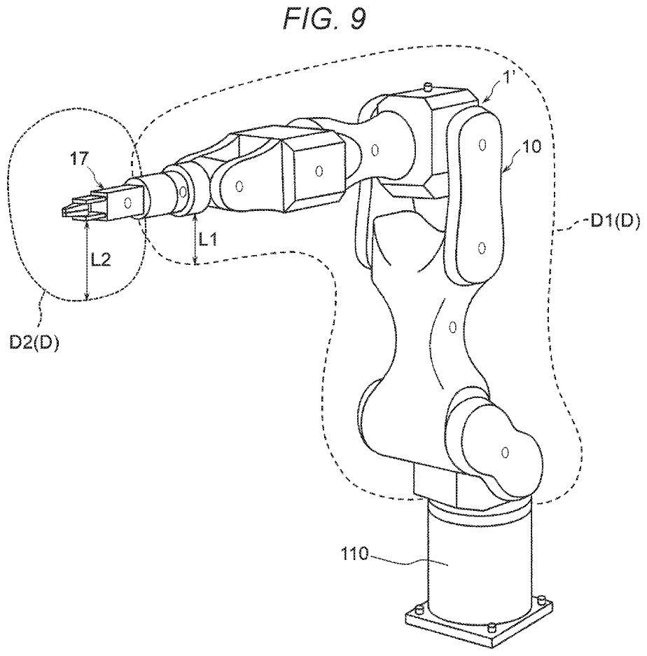

FIG. 7 is a perspective view showing a robot according to a second embodiment of the present disclosure. FIG. 8 is a block diagram of the robot shown in FIG. 7. FIG. 9 is a diagram showing an example of the monitoring area D in which the proximity sensors 231 shown in FIG. 7 detect that a physical body exists.

The second embodiment will hereinafter be described focusing mainly on the differences from the embodiment described above, and the description of substantially the same matters will be omitted. It should be noted that in FIG. 7 through FIG. 9, the constituents substantially the same as those of the first embodiment described above are denoted by the same reference symbols.

The robot 1′ shown in FIG. 7 and FIG. 8 has a proximity sensor 232 (a sensor section) provided to the end effector 17 in addition to the proximity sensors 231 provided to the robot arm 10. As the proximity sensor 232, substantially the same sensor as the proximity sensor 231 described above can be used. Specifically, the proximity sensor 232 is disposed around the surface of the end effector 17 disposed closer to the tip than the robot arm 10, and is arranged to be able to detect a distance (substituted by a sensor output value in some cases) between the surface of the end effector 17 and a human or an object (a physical body) approaching the surface. It should be noted that the proximity sensors 232 can also be disposed at a place other than on the surface of the end effector 17 such as inside the end effector 17 or at a position floating from the surface of the end effector 17. Further, the number of the proximity sensors 232 can also be 1, or two or more.

In FIG. 9, a first monitoring area set based on the detection result by the proximity sensors 231 is denoted by D1, and a second monitoring area set based on the detection result by the proximity sensor 232 is denoted by D2. Further, the area obtained by combining the first monitoring area D1 and the second monitoring area D2 with each other corresponds to the monitoring area D described above. In other words, the monitoring area D (the predetermined area) includes the first monitoring area D1 (a first area) set in the periphery of the robot arm 10 and the second monitoring area D2 (a second area) set closer to the tip than the first monitoring area D1 and in the periphery of the end effector 17 in the present embodiment. In other words, the first monitoring area D1 is disposed closer to the platform 110 than the second monitoring area D2.

According to such a robot 1′, it is configured to include the periphery of the end effector 17 in the range of the monitoring area D. Therefore, the fact that there is a possibility that a human or an object comes into contact with the end effector 17 can be detected in advance. Thus, it is configured to reset the force sensor 21 at an appropriate timing at which no external force is acting on the force sensor 21 to thereby keep the detection accuracy of the force sensor 21 at a high level. As a result, it is configured to enhance the safety and the reliability of the robot 1′.

Further, an average value of a detectable range L2 of the proximity sensor 232 (the sensor section) in the second monitoring area D2 (the second area) can be shorter than, or equal to an average value of a detectable range L1 of the proximity sensors 231 (the sensor section) in the first monitoring area D1 (the first area), but may be longer (greater) than the average value of the detectable range L1. Thus, it is configured to detect the approach of a human or an object (a physical body) in an earlier stage with respect to the second monitoring area D2 set in the periphery of the end effector 17 having more chances to have contact with the component and so on during the work than in the first monitoring area D1. Therefore, even when there is a possibility that the end effector 17 comes into contact with the component when, for example, an operation of making the end effector 17 come closer to the component is performed, the force sensor 21 is prevented from being reset at an inappropriate timing by sufficiently ensuring the temporal extension described above. As a result, it is configured to realize the robot 1′ more excellent in safety and reliability.

It should be noted that the average value of the detectable range L2 of the proximity sensor 232 in the second monitoring area D2 denotes an average value of a separation distance between an outer edge of the second monitoring area D2 and the proximity sensor 232.

Similarly, the average value of the detectable range L1 of the proximity sensors 231 in the first monitoring area D1 denotes an average value of a separation distance between an outer edge of the first monitoring area D1 and the proximity sensors 231.

Further, the first monitoring area D1 and the second monitoring area D2 can partially overlap each other, or can be separated from each other.

Further, when two or more proximity sensors 232 are provided, the second monitoring area D2 is defined as an area obtained by combining the detectable ranges which the respective proximity sensors have charge of.

Further, in the present embodiment, it is also configured to make the control content of the robot 1′ by the control device 50 different between the first monitoring area D1 and the second monitoring area D2.

Specifically, the control device 50 according to the present embodiment detects that a human or an object has entered the first monitoring area D1 using the proximity sensors 231, and then determines not to transmit the reset signal to the force sensor 21 based on the detection result, but in addition, it is also configured to arrange that the control device 50 stops or decelerates the operation of the robot arm 10 or the end effector 17 based on the detection result by the proximity sensors 231.

Similarly, the control device 50 according to the present embodiment detects that a human or an object has entered the second monitoring area D2 using the proximity sensor 232, and then determines not to transmit the reset signal to the force sensor 21 based on the detection result, but in addition, it is also configured to arrange that the control device 50 decelerates the operation of the robot arm 10 or the end effector 17 based on the detection result by the proximity sensor 232. By detecting that a human or an object has entered the second monitoring area D2 for monitoring the periphery of the end effector 17, and then decelerating the operation of the robot arm 10 or the end effector 17, it is configured to reduce a risk that a human comes into contact with the end effector 17 operating fast to thereby be injured. In addition, it is configured to avoid the state in which the work steps every time the end effector 17 approaches the component (the target). In view of the above, the embodiment described above is particularly excellent due to the proximity sensor 232 alone regardless of the feature with respect to the reset signal for the force sensor 21.

It should be noted that regarding the detection result by the proximity sensor 232, it can also be arranged that the detection result is used as a condition for determining whether to reset the force sensor on the one hand, but is not used as a condition for stopping or decelerating the operation of the robot arm 10 or the end effector 17 on the other hand on an as-needed basis. In other words, the control device 50 can also be arranged to use the detection result by the proximity sensor 232 only as the condition based on which whether to reset the force sensor 21 is determined. Thus, an unnecessary operation restriction that the operation of the robot arm 10 and so on is stopped or decelerated every time the end effector 17 approaches the component or the like can be prevented from occurring. As a result, it is configured to reset the force sensor 21 at an appropriate timing while preventing an unnecessary operation restriction, and thus it is configured to keep the detection accuracy of the force sensor 21 in a high level. Further, it is also configured to arrange that the detection result by the proximity sensor 232 is used only as the condition based on which whether to reset the force sensor 21 is determined with respect to the second monitoring area D2 on the one hand, and the detection result by the proximity sensor 232 is used also as the condition based on which the operation of the robot arm 10 or the end effector 17 is stopped or decelerated in addition to the condition based on which whether to reset the force sensor is determined with respect to the first monitoring area D1 on the other hand.

According also to such a second embodiment as described hereinabove, substantially the same advantages as in the first embodiment described above can be exerted.

### Third Embodiment

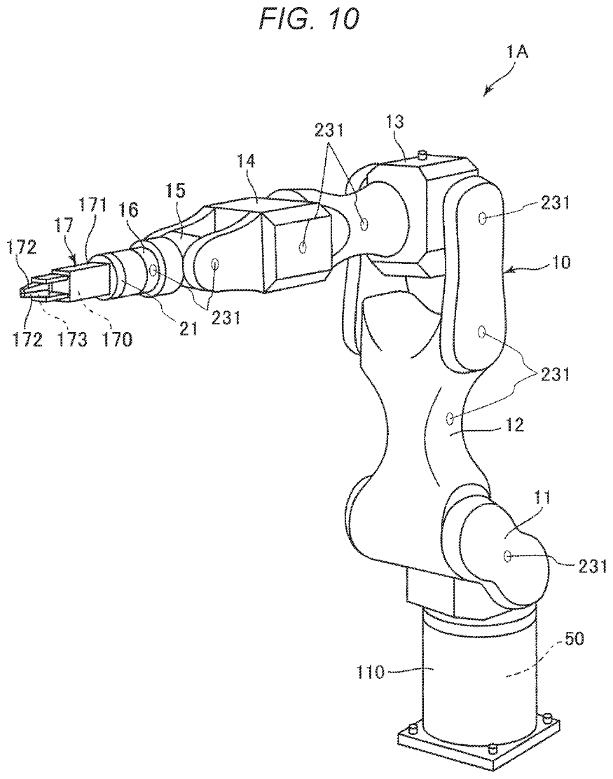

FIG. 10 is a perspective view showing a robot according to a third embodiment of the present disclosure.

The third embodiment will hereinafter be described focusing mainly on the differences from the embodiments described above, and the description of substantially the same matters will be omitted. It should be noted that in FIG. 10, the constituents substantially the same as those of the first embodiment described above are denoted by the same reference symbols.

In the robot 1 shown in FIG. 1 described above, the force sensor 21 is disposed closer to the base end than the robot arm 10, while the force sensor 21 is disposed closer to the tip than the robot arm 10 in the robot 1A shown in FIG. 10. In other words, the force sensor 21 shown in FIG. 10 is disposed between the robot arm 10 and the end effector 17.

Since the force sensor 21 is disposed at such a position, it is configured for the force sensor 21 to efficiently detect the external force applied to the periphery of the end effector 17 particularly easy to come into contact with a human or an object.

According also to such a third embodiment as described hereinabove, substantially the same advantages as in the first embodiment described above can be exerted.

It should be noted that the installation position of the force sensor 21 is not limited to the position in the first embodiment or the position in the present embodiment, but can also be other positions such as the inside of the robot arm 10.

### Fourth Embodiment

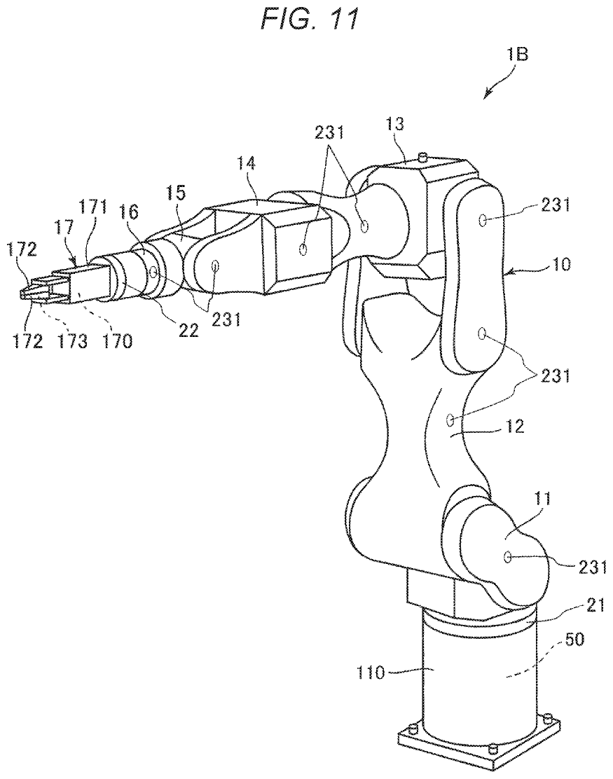

FIG. 11 is a perspective view showing the robot according to a fourth embodiment of the present disclosure.

The fourth embodiment will hereinafter be described focusing mainly on the differences from the embodiments described above, and the description regarding substantially the same matters will be omitted. It should be noted that in FIG. 11, the constituents substantially the same as those of the first embodiment described above are denoted by the same reference symbols.

In the robot 1 shown in FIG. 1 described above, the force sensor 21 is disposed closer to the base end than the robot arm 10, while another force sensor 22 than the force sensor 21 is added closer to the tip than the robot arm 10 in the robot 1B shown in FIG. 11. In other words, the robot 1B shown in FIG. 11 is provided with the two force sensors, namely the force sensor 21 and the force sensor 22.

By providing the force sensors 21, 22 in such a manner, it is possible for the robot 1B to more accurately detect the external force applied thereto to thereby further stabilize the operation of the robot 1B.

Further, both of the force sensors 21, 22 are arranged to be reset in such a manner as in the first embodiment. Thus, it is configured to keep the detection accuracy in a high level with respect to both of the force sensors 21, 22.

According also to such a force embodiment as described hereinabove, substantially the same advantages as in the first embodiment described above can be exerted.

It should be noted that the number of the force sensors is not limited to two, but can also be three or more.

Further, it is also configured to arrange that either one of the force sensors 21, 22 is reset using the method described above, and the other is reset using another method.

### Fifth Embodiment

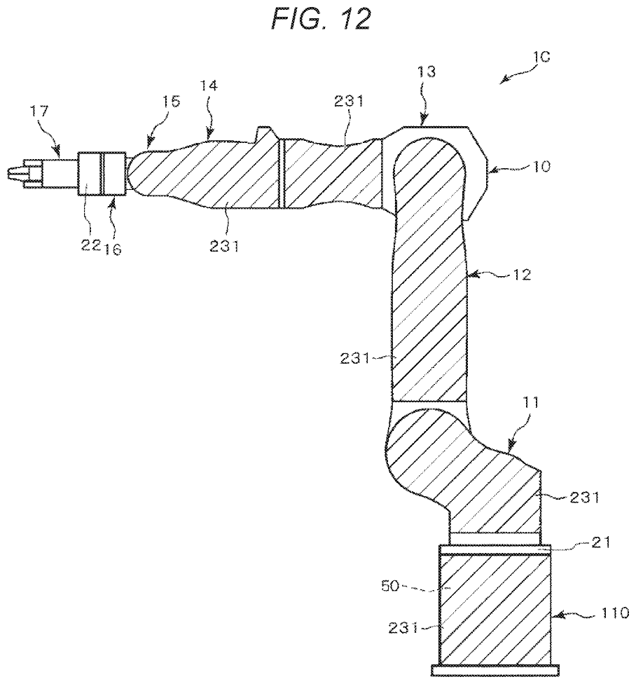

FIG. 12 is a diagram showing a robot according to a fifth embodiment of the present disclosure.

The fifth embodiment will hereinafter be described focusing mainly on the differences from the embodiments described above, and the description of substantially the same matters will be omitted. It should be noted that in FIG. 12, the constituents substantially the same as those of the first embodiment described above are denoted by the same reference symbols.

In the robot 1 shown in FIG. 1 described above, the plurality of proximity sensors 231 is arranged at arbitrary intervals along the surface of the robot arm 10, while in the robot 1C shown in FIG. 12, the proximity sensors 231 are each arranged on the outer surface side (an outer surface of an exterior member) of each of the platform 110 and the arms 11 through 14. Specifically, in the robot 1C shown in FIG. 12, the proximity sensors 231 cover the periphery of the robot arm 10 and the platform 110.

Further, by providing the force sensors 21, 22, it is possible for the robot 1C to more accurately detect the external force applied thereto to thereby further stabilize the operation of the robot 1C.

According also to such a fifth embodiment as described hereinabove, substantially the same advantages as in the first embodiment described above can be exerted.

Although the robot, the control device and the method of controlling the robot according to the present disclosure are hereinabove described based on the embodiment shown in the drawings, the present disclosure is not limited to the embodiments, but the configuration of each of the components can be replaced with one having an equivalent function and an arbitrary configuration. Further, it is also configured to add any other constituents to the present disclosure.

Further, the present disclosure can be a combination of any two or more of configurations (features) out of the embodiments described above.

Further, the robot according to the present disclosure is not limited to a single-arm robot providing the robot has the robot arm, and can also be another robot such as a dual-arm robot or a scalar robot. Further, the number of the arms (the number of the joints) provided to the robot arm is not limited to the number (six) in the embodiments described above, but can also be in a range from one to five, or not smaller than seven.

Further, the control device according to the present disclosure can widely be applied to all sorts of devices having a movable section besides the robot.

What is claimed is:

1. A robot comprising:
a platform;
a robot arm configured to rotate relatively to the platform;
a force sensor configured to detect an external force; and
a sensor section configured to detect that a physical body exists in a predetermined area set along the robot arm, wherein
a detection value by the force sensor is corrected when the robot arm is one of at rest and operating at a uniform speed, and it is determined that no physical body exists in the predetermined area based on a detection result by the sensor section.

2. The robot according to claim 1, wherein
the force sensor is disposed between the robot arm and the platform.

3. The robot according to claim 1, wherein
the force sensor is disposed between the robot arm and an end effector.

4. The robot according to claim 1, wherein
the predetermined area includes a first area and a second area set along the robot arm, and
the first area is disposed closer to the platform than the second area.

5. The robot according to claim 4, wherein
an average value of a detectable range of the sensor section in the second area is larger than an average value of a detectable range of the sensor section in the first area.

6. The robot according to claim 1, wherein
the force sensor is a sensor including a quartz crystal.

7. A robot comprising:
a robot arm;
a force sensor configured to detect an external force;
a sensor section configured to detect that a physical body exists in a predetermined area set along the robot arm; and
a processing section configured to correct a detection value by the force sensor when the robot arm is one of at rest and operating at a uniform speed, and it is determined that no physical body exists in the predetermined area based on a detection result by the sensor section.

8. A control device configured to:
output a signal for correcting a detection value of a force sensor configured to detect an external force applied to a robot arm during a period in which the robot arm is at rest or operating at a uniform speed in response to a signal of detecting that no physical body exists in the predetermined area.

9. A method of controlling a robot having a robot arm, and a force sensor configured to detect an external force, the method comprising:
detecting that a physical body exists in a predetermined area set along the robot arm; and
correcting a detection value by the force sensor when the robot arm is one of at rest and operating at a uniform speed, and it is determined that no physical body exists in the predetermined area.
